(19) United States
(12) Patent Application Publication
(10) Pub. No.: US 2024/0419740 A1
(43) Pub. Date: Dec. 19, 2024

(54) DYNAMIC COMPUTER LOG STORAGE

(71) Applicant: International Business Machines Corporation, Armonk, NY (US)

(72) Inventors: Michele Crudele, Rome (IT); Luca Ioffredo, Pozzuoli (IT); Francesca De Cicco, Rome (IT); Fabio Monopoli, Rome (IT)

(21) Appl. No.: 18/336,237

(22) Filed: Jun. 16, 2023

(51) Int. Cl. G06F 16/908

(52) U.S. Cl. CPC G06F 16/908

(57) ABSTRACT

Disclosed embodiments provide techniques for dynamic computer log storage. Log data is obtained, and templates are created from the log data. A parameter count is identified, and a score for each log line is computed, based on the parameter count, and/or additional information, such as the novelty and/or the throughput rate of the log line. Each log line is scored, and based on the score, a storage strategy is applied to the log line. When scoring indicates a potentially important log line, log lines that temporally preceded and followed that log line are saved in short-term log storage, so they can be reviewed in the event that troubleshooting is needed. In this way, the cost of long-term storage for log files can be reduced considerably, while still preserving important information that is useful for maintenance, troubleshooting, and operation of deployed devices and/or software applications and systems.

### FIELD

The present invention relates generally to computer systems, and more particularly, to dynamic computer log storage.

### BACKGROUND

Computer processors play a very important role in today's world across a wide range of industries and applications. Computers allow people to perform various tasks such as browsing the internet, running applications, processing data, and communicating with others. Additionally, computers are fundamental to the growth of the Internet of Things (IoT). They are embedded in smart devices, sensors, and appliances, enabling connectivity and data processing. Computers enable IoT devices to collect, analyze, and transmit data, enabling automation, remote monitoring, and control of various systems, including smart homes, industrial automation, healthcare devices, and more. Furthermore, computers are key components in communication and networking technologies. They are found in routers, switches, and modems, facilitating communication, data transmission, and network management.

These computing systems and applications generate vast amounts of data resulting from the operation of those computing systems and applications. In some cases, hundreds of megabytes of diagnostic output, in the form of various log files, may be generated. These vast amounts of data are stored in designated locations, such as log files/records, which can then be reviewed at a later time period in the event of an error or anomaly in the operation of the system or application.

### SUMMARY

In one embodiment, there is provided a computer-implemented method for log processing, comprising: obtaining log data; creating a log template based on the obtained log data; identifying a parameter count in the log template; computing a score for a log line within the log data that measures an estimated importance of the log line, wherein the score is a function of the parameter count; and storing the log line to a storage location, wherein the storage location is based on the score, wherein a different log line within the log data is stored to a different storage location based on a computed score associated with the different log line.

In another embodiment, there is provided an electronic computation device comprising: a processor; a memory coupled to the processor, the memory containing instructions, that when executed by the processor, cause the electronic computation device to: obtain log data; create a log template based on the obtained log data; identify a parameter count in the log template; compute a score for a log line within the log data that measures an estimated importance of the log line, wherein the score is a function of the parameter count; and store the log line to a storage location, wherein the storage location is based on the score, wherein a different log line within the log data is stored to a different storage location based on a computed score associated with the different log line.

In yet another embodiment, there is provided a computer program product for an electronic computation device comprising a computer readable storage medium having program instructions embodied therewith, the program instructions executable by a processor to cause the electronic computation device to: obtain log data; create a log template based on the obtained log data; identify a parameter count in the log template; compute a score for a log line within the log data that measures an estimated importance of the log line, wherein the score is a function of the parameter count; and store the log line to a storage location, wherein the storage location is based on the score, wherein a different log line within the log data is stored to a different storage location based on a computed score associated with the different log line.

### BRIEF DESCRIPTION OF THE DRAWINGS

FIG. 1 is an exemplary computing environment in accordance with disclosed embodiments.

FIG. 2 is an exemplary ecosystem in accordance with disclosed embodiments.

FIG. 3 is a flowchart indicating process steps for embodiments of the present invention.

FIG. 4 is a flowchart indicating process steps for additional embodiments of the present invention.

FIG. 5 is an exemplary log file used with embodiments of the present invention.

FIG. 6 is an exemplary user interface in accordance with embodiments of the present invention.

The drawings are not necessarily to scale. The drawings are merely representations, not necessarily intended to portray specific parameters of the invention. The drawings are intended to depict only example embodiments of the invention, and therefore should not be considered as limiting in scope. In the drawings, like numbering may represent like elements. Furthermore, certain elements in some of the Figures may be omitted, or illustrated not-to-scale, for illustrative clarity.

### DETAILED DESCRIPTION

Long-term storage for log files is important for successful operation of many enterprises. Often, it is valuable to review past logs to determine when a problem started. This can be important for investigation of system failures, cybersecurity incidents, and/or other important issues. In one or more embodiments, long-term storage is implemented as cloud-based storage. Cloud-based storage solutions provide many advantages by storing data remotely, eliminating the need to retain it on physical on-premise hardware. Information stored in the cloud can be accessed at any time and from anywhere. For enterprise systems, and/or large numbers of deployed devices such as mobile phones, broadband modems, and set top boxes, log files from computer operations are often stored using cloud-based storage solutions. Although the aforementioned benefits are compelling reasons to use cloud-based storage for log files, there are also costs associated with cloud-based storage. The cost of enterprise cloud storage can vary greatly depending on particular use cases. Accessing data, retrieval frequency, and network bandwidth all contribute to the cost. Cloud storage has costs beyond the storage itself, such as costs associated with the transfer of data in and out of the cloud to access log data. A similar issue exists with disaster recovery (DR) and backup functions, where charges can be incurred for data traffic between domains to keep a second disaster recovery (DR) or failover environment in a different region or availability zone. Unnecessary storage can increase costs, and therefore, excessive logging produced by programs, devices, and/or applications can contribute to the cost of logging with little to no benefits. Disclosed embodiments address the aforementioned problems.

Disclosed embodiments provide techniques for dynamic computer log storage. Log data is obtained, and templates are created from the log data. The templates can include placeholders for parameters. The parameters can include strings and numbers, such as dates, addresses, port numbers, user identifiers, and so on. A parameter count is identified, and a score for each log line is computed, based on the parameter count, and/or additional information, such as the novelty of the log line and/or the throughput rate of the log line. Additionally, in one or more embodiments, one or more user-configurable keywords are used as a factor in determining the score of log lines.

In general, devices and applications generate hundreds of log lines, which often includes some important log lines mixed in with mostly unimportant log lines. In disclosed embodiments, each log line is scored, and based on the score, a storage strategy is applied to the log line. The storage strategy can include storing the log line in a short-term first-in first-out (FIFO) log storage. The storage strategy can include storing the log line in a long-term, cloud-hosted log storage. The storage strategy can include storing the log line in a cloud-hosted log storage and also clearing out the short-term first-in first-out (FIFO) log storage, followed by storing log lines in the short-term first-in first-out (FIFO) log storage that temporally precede and temporally follow the log line that was stored in the cloud-hosted log storage. In this way, when scoring indicates a potentially important log line, log lines that temporally preceded and followed that log line are saved in the short-term first-in first-out (FIFO) log storage, so they can be reviewed by engineers and/or other support personnel in the event that troubleshooting is needed. In this way, the cost of cloud-hosted storage for log files can be reduced considerably, while still preserving important information that is useful for maintenance, troubleshooting, and operation of deployed devices and/or software applications and systems.

Reference throughout this specification to “one embodiment,” “an embodiment,” “some embodiments”, or similar language means that a particular feature, structure, or characteristic described in connection with the embodiment is included in at least one embodiment of the present invention. Thus, appearances of the phrases “in one embodiment,” “in an embodiment,” “in some embodiments”, and similar language throughout this specification may, but do not necessarily, all refer to the same embodiment.

Moreover, the described features, structures, or characteristics of the invention may be combined in any suitable manner in one or more embodiments. It will be apparent to those skilled in the art that various modifications and variations can be made to the present invention without departing from the spirit and scope and purpose of the invention. Thus, it is intended that the present invention cover the modifications and variations of this invention provided they come within the scope of the appended claims and their equivalents. Reference will now be made in detail to the preferred embodiments of the invention.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The term “set” is intended to mean a quantity of at least one. It will be further understood that the terms “comprises” and/or “comprising”, or “includes” and/or “including”, or “has” and/or “having”, when used in this specification, specify the presence of stated features, regions, integers, steps, operations, elements, and/or components, but do not preclude the presence or addition of one or more other features, regions, or elements.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

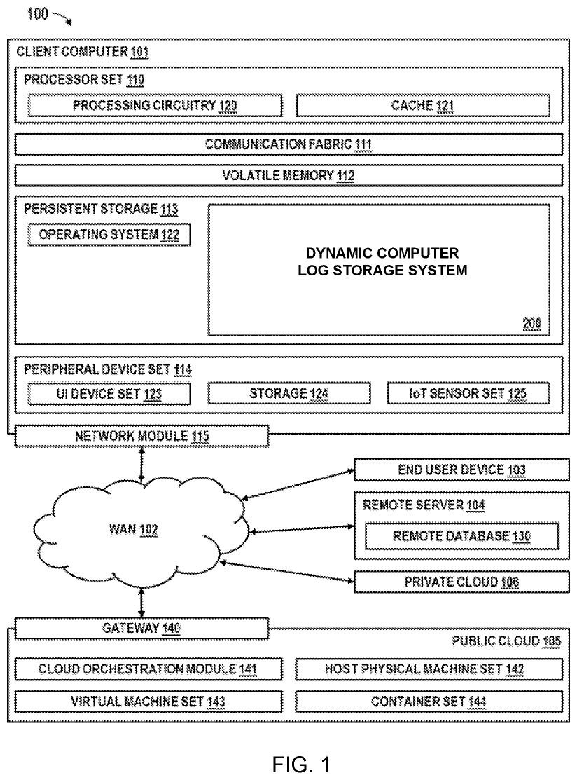

FIG. 1 shows an exemplary computing environment 100 in accordance with disclosed embodiments. Computing environment 100 contains an example of an environment for the execution of at least some of the computer code involved in performing the inventive methods, such as dynamic computer log storage system block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

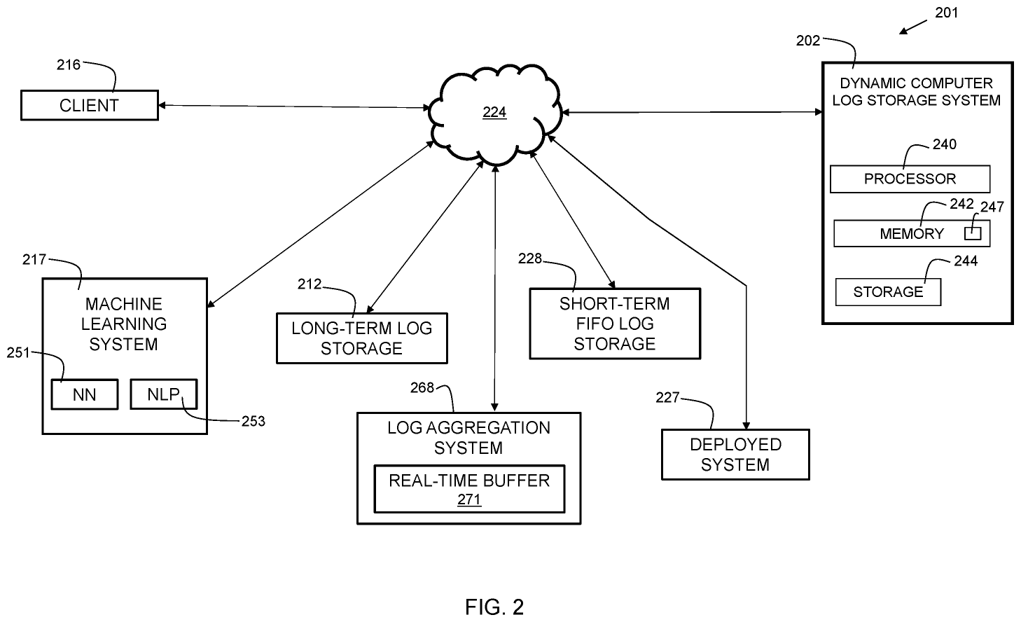

FIG. 2 is an exemplary ecosystem 201 in accordance with disclosed embodiments. Dynamic Computer Log Storage System (DCLSS) 202 comprises a processor 240, a memory 242 coupled to the processor 240, and storage 244. DCLSS 202 is an electronic computation device. The memory 242 contains program instructions 247, that when executed by the processor 240, perform processes, techniques, and implementations of disclosed embodiments. Memory 242 can include dynamic random-access memory (DRAM), static random-access memory (SRAM), magnetic storage, and/or a read only memory such as flash, EEPROM, optical storage, or other suitable memory, and should not be construed as being a transitory signal per se. In some embodiments, storage 244 may include one or more magnetic storage devices such as hard disk drives (HDDs). Storage 244 may additionally include one or more solid state drives (SSDs). The DCLSS 202 is configured to interact with other elements of ecosystem 201. DCLSS 202 is connected to network 224, which may include the Internet, a wide area network, a local area network, and/or other suitable network.

Ecosystem 201 may include one or more client devices, indicated as 216. Client device 216 can include a laptop computer, desktop computer, tablet computer, or other suitable computing device. Client device 216 may be used to interact with DCLSS 202 to enable end-users to configure the DCLSS for dynamic log storage, including features such as establishing keywords to use in the scoring, as well as additional filtering and/or storage options.

Ecosystem 201 may include a log aggregation system 268. In one or more embodiments, log aggregation system 268 collects logs from devices and/or deployed software. The log aggregation system 268 may store logs as well as perform some processing functions on the logs. Log files are typically text-based files that contain information about the operation of the device. Warnings, errors, and other unexpected conditions may be written to one or more log files. The computing devices within deployed system 227 then can upload the log files to the log aggregation system 168 on a regular basis. On the log aggregation system 168, certain text strings and/or patterns, are identified as indicative of an error or other problem warranting investigation. The log aggregation system 168 may include or interface with log processing tools such as Splunk®, Loggly®, or other suitable tools. In one or more embodiments, the DCLSS 202 computes a score for each log line. In one or more embodiments, the score of a log line determines where that log line is to be stored, and for how long. In embodiments, the score is a measure of the importance of a given log line. By prioritizing important log lines for cloud-hosted storage, and storing less important log lines in a more economical storage, such as local storage, disclosed embodiments can save considerable costs on cloud storage while still enabling effective diagnostics and maintenance of deployed devices and/or applications.

Ecosystem 201 includes a deployed system 227. The deployed system 227 can include large numbers of deployed devices such as mobile phones, broadband modems, and set top boxes. The deployed system 227 can include an enterprise-level system such as an ecommerce system, banking system, reservation/ticketing system, and so on. The deployed system 227 generates log files that are periodically or continuously uploaded to the log aggregation system 268. In some embodiments, the deployed system 227 may compress log files prior to uploading them, to reduce network bandwidth usage. In these cases, the log aggregation system may decompress the log files into the real-time buffer 271, such that the log lines can be scored by the DCLSS 202.

Ecosystem 201 may include machine learning system 217. The machine learning system 217 can include a neural network (NN) 251, and/or a natural language processing (NLP) module 253. In some embodiments, the machine learning system 217 may include a Support Vector Machine (SVM), Decision Tree, Recurrent Neural Network (RNN), Long Short Term Memory Network (LSTM), Radial Basis Function Network (RBFN), Multilayer Perceptron (MLP), and/or other suitable neural network type. In embodiments, the machine learning system 217 is trained using supervised learning techniques.

The NLP module 253 may include software and/or hardware for performing Natural Language Processing (NLP). NLP is a subfield of artificial intelligence that involves teaching computers to understand, interpret, and/or generate human language. NLP works by breaking down human language into its constituent parts and analyzing them using various algorithms and techniques. In one or more embodiments, the NLP process includes tokenization, which can include breaking down a piece of text into individual words or phrases. The NLP process can further include Part-of-speech (POS) tagging. POS tagging can include analyzing each token and assigning it a part of speech, such as noun, verb, adjective, or adverb. The NLP process can further include parsing, which involves analyzing the syntactic structure of a sentence to identify the relationships between the words and phrases. The process can include entity detection, which involves identifying and categorizing named entities in a piece of text, such as people, places, organizations, and dates. In one or more embodiments, the NLP process may be used on log data to identify the parameters of a log line, such as numbers, portions of JSON objects, dates, and so on, which helps to identify the log record template corresponding to a given log line. In this way, keywords can be automatically extracted and used for scoring of log lines in one or more embodiments.

The log aggregation system 268 further includes real-time buffer 271. The real-time buffer 271 stores log lines as they arrive from various devices and/or applications. The log lines may be scored by the DCLSS 202. Once scored, the log lines may be stored in long-term log storage 212, or short-term FIFO log storage 228. In one or more embodiments, long-term log storage 212 may be cloud-hosted log storage, and short-term FIFO log storage 228 may be local (non-cloud-hosted) storage, such as stored on a hard disk of a server. In embodiments, once the short-term FIFO log storage 228 is full, the oldest log lines may be overwritten as new log lines arrive. Log lines that are deemed important, based on scoring, are sent to the long-term log storage 212. The size of the short-term FIFO log storage 228 and the size of the long-term log storage 212 are configurable based on user and/or application requirements. In embodiments, the short-term FIFO log storage is a circular buffer of a configurable size. In embodiments, the short-term FIFO log storage 228 has a capacity of X megabytes (MB), while the long-term log storage 212 has a capacity of Y megabytes (MB), where X<Y. In some embodiments, Y may be orders of magnitude larger than X. As an example, X may have a value of 1,000,000 (one terabyte (TB)), while Y may have a value of 5,000,000,000 (five petabytes). In other embodiments, Y may be smaller than X. As an example, X may have a value of 5,000,000 (five terabytes (TB)), while Y may have a value of 1,000,000 (1 TB). A key difference in the storage locations is that the short-term FIFO log storage may be non-cloud-hosted storage, and thus, much more economical for storing log lines. The long-term log storage 212 has costs associated with storage and/or access of stored data. Disclosed embodiments store less important log lines in the short-term FIFO log storage 228 where they persist until they are overwritten or erased during the course of operation. In contrast, the long-term log storage 212 may be long-term or permanent, and therefore is well-suited for logging important log lines, as identified by an associated score. In this way, less important log lines do not incur costs associated with cloud storage.

In some situations, an important log line such as a critical error may be encountered. In these cases, it may be desirable for users, such as engineers and technicians, to have access to log lines leading up to, and following, the important log line. In disclosed embodiments, when an important log line, as indicated by a score exceeding a predetermined value, is saved to the long-term log storage 212, the short-term FIFO log storage 228 is written to the long-term storage 212, such that the long-term storage 212 contains log lines leading up to, and following the important log lines. In this way, users can review the full log history surrounding an important log line, to obtain a complete understanding of what occurred. In some embodiments, the log lines from the real-time buffer 271 are transferred to the long-term log storage 212 in addition to, or instead of the short-term FIFO log storage 228. In this way, log lines that are temporally adjacent to an important log line such as a critical error, failure, warning, and the like, can be archived for further analysis at a later time.

Note that while one computer system is shown for DCLSS 202, in practice, disclosed embodiments can include multiple DCLSS 202. In some embodiments, multiple DCLSS 202 may be implemented on virtual machines and/or as containerized applications. In some embodiments, load balancers may be utilized to enable scalability for the DCLSS 202, allowing the DCLSS 202 to handle enterprise-level logging applications.

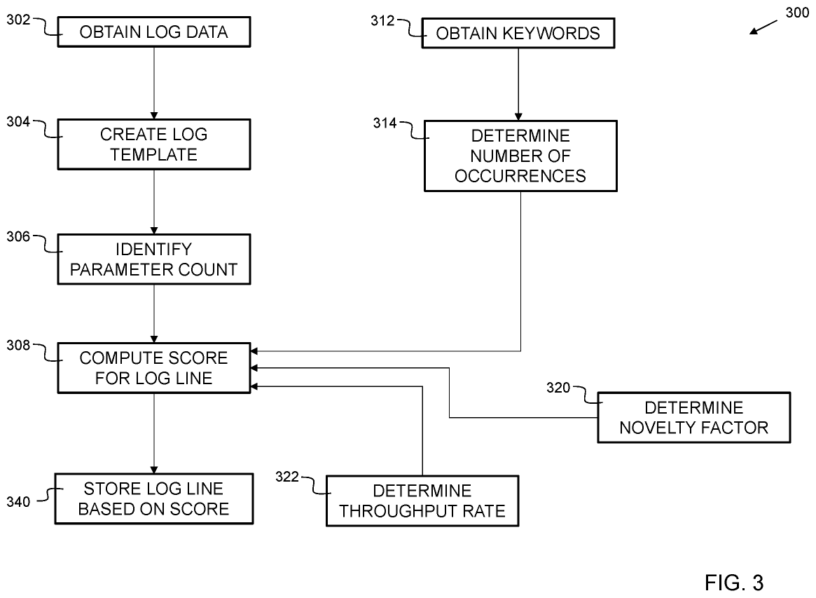

FIG. 3 is a flowchart 300 indicating process steps for embodiments of the present invention. At block 302, log data is obtained. The log data can be in a text format. The log data can be in a structured format, such as an XML format, CSV format, tab-delimited format, JSON format, and/or other suitable format. At block 304, log templates are created. The log templates generalize log statements that include parameters. The parameters can include strings and/or numbers. As an example, a log line such as “Retrying transmission of 512 bytes in 220 milliseconds” includes two parameters, which include a number of bytes and a number of milliseconds. In this example, a template for the above log line can be denoted as “Retrying transmission of % d bytes in % d milliseconds.” In the template, the token ‘% d’ denotes a placeholder for a numeric value. In embodiments, the templates may be created automatically based on heuristics and/or machine learning. By using the template, two similar log lines with different values are treated as occurrences of a log line for the purposes of scoring. Continuing with the aforementioned example, the log line “Retrying transmission of 512 bytes in 220 milliseconds” and the log line “Retrying transmission of 1024 bytes in 408 milliseconds” both match the template, and hence, when each of these log lines are encountered, it counts as an occurrence of a log line matching the template “Retrying transmission of % d bytes in % d milliseconds.” Other templates can include strings in addition to, or instead of, numbers. As an example, a log line “Error writing file testing.txt to/dev/sda3” maps to a template of line “Error writing file % s to % s.” Continuing with the aforementioned example, the log line “Error writing file testing.txt to/dev/sda3” and the log line “Error writing file calibration.dat to/nvram/calibration” both match the template, and hence, when each of these log lines are encountered, it counts as an occurrence of a log line matching the template “Error writing file % s to % s.”

The process continues to block 306, where a parameter count is identified. In embodiments, the more parameters there are in a log template, the higher the importance it is. A log line may have zero parameters. An example of such a log line is “Error: memory full.” A log line may have multiple parameters. An example of such a log line is “Warning: User bobby765 attempting telnet to 192.168.100.100 and port 22 with invalid credentials.” In the aforementioned example, the log line contains three parameters, including a user name (bobby765), an IP address (192.168.100.100), and a port number (22). In general, the more parameters there are in a log line, the more useful is the information that it conveys. Thus, disclosed embodiments include computing a score for a log line within the log data, wherein the score is a function of the parameter count.

At block 308, a score is computed for a log line. The score of the log line can be based on the parameter count identified at block 306. In embodiments, a higher score indicates a semantically more important log line, and a higher parameter count value correlates to a higher score. That is, the score is a function of the parameter count. The process can include obtaining keywords at block 312. At block 314 a number of occurrences of the keywords is determined. In one or more embodiments, the number of occurrences is used as a criterion in determining the score, with more occurrences indicating a higher score, and thus, a higher level of importance. In some embodiments, the rate of occurrence of keywords may be used instead of, or in addition to, the number of occurrences, as a criterion for determining the score. The rate of occurrence can be denoted in number of lines per minute, or other suitable units. At block 320, a novelty factor may be determined. A novelty factor is a measure of the rarity of a given log line. The concept is that a log line that does not occur very often may have increased importance, and may be saved to long-term storage so that it persists for longer than less important log lines that are put in a short-term FIFO log storage. At block 322 a throughput rate is determined. This can include a number of log lines per minute that match a given template. In some embodiments, an average rate for a given log line template is recorded in the DCLSS 202. In the event that the rate fluctuates higher or lower, it can cause the score to increase, flagging the log line for storage in the long-term storage instead of the short-term FIFO log storage.

Returning to block 308, the score is computed based on a variety of factors, including, but not limited to, the parameter count, the novelty factor, the throughput rate, and/or the rate of occurrence of a keyword in a log line. In one or more embodiments, the measure of the novelty utilizes the inverse record frequency (IRF) computed as:

IRF(rt)=log(M/K)
where:
log is the logarithm function;
rt=the log template;
M=the total number of log records observed in a time window; and
K=the number of records originated from the template rt observed in the same time window.

In one or more embodiments, the throughput is specified in terms of number of log records of a given template per time unit. The rationale is that a record with a high throughput is signaling an anomalous activity of the source, and therefore, it is likely to be important. The throughput of a log line is denoted as TP(rt).

As stated previously, templates having more parameters generally convey more information compared to those with fewer or no parameters at all. The number of parameters is denoted as PC(rt), which is the number of parameters of a log template.

In one or more embodiments, predetermined, user-configured keywords can be used to identify log templates of elevated importance. Examples of such keywords can include words such as ‘error,’ ‘warning,’ ‘failure,’ and the like. Disclosed embodiments boost the importance of record templates that contain those keywords in the text message by a KW (rt) factor.

In embodiments, using the aforementioned factors, a score is computed for each log line. In some embodiments, the score is computed as:

$$SCORE ( rt ) = TP ( rt ) * ( 1 + k ) / ( TP ( r t ) + k ) ⋆ IRF ( rt ) * KW ( rt )$$

The first term TP(rt)*(1+k)/(TP(rt)+k) is introduced to penalize rt in cases where throughput is too high, because excessively high throughput can skew the score higher without the aforementioned term. Disclosed embodiments address this situation by introducing a saturation for high values of TP (rt). Disclosed embodiments can further include a boost for rt with more parameters, thereby introducing a pivot normalization:

1+b−b*PC (rt) at the denominator of the first term.

A high value of PC (rt) makes the denominator smaller and so makes the SCORE higher. In these embodiments, the formula for the SCORE is denoted as:

$$SCORE ( rt ) = TP ( rt ) * ( 1 + k ) / ( TP ( rt ) + k * ( 1 + b - b * PC ( rt ) ) ) * IRF ( rt ) * KW ( rt )$$

where k and b are configurable positive values set during the tuning of disclosed embodiments. Thus, embodiments can include, determining a novelty factor for the log line; determining a throughput rate for the log line; wherein computing the score is further based on the novelty factor and the throughput rate; wherein in response to the score being below a first predetermined threshold, the log line is stored in a short-term FIFO storage; wherein in response to the score being at or above the first predetermined threshold and below a second predetermined threshold, the log line is stored in a long-term storage; and wherein in response to the score being at or above the first predetermined threshold and at or above the second predetermined threshold: storing the log line in a long-term storage; storing a first plurality of log lines that temporally precede the log line that was stored in the long-term storage, in the long-term storage; and storing a second plurality of log lines that temporally follow the log line that was stored in the long-term storage, in the long-term storage. Log lines not included in the aforementioned pluralities of log lines may remain in the short-term FIFO storage, until they are eventually overwritten by newer log lines. The process continues with storing the log line at block 340. In embodiments, the log lines that are stored are log lines that immediately precede and immediately follow the log line that was stored in the long-term storage.

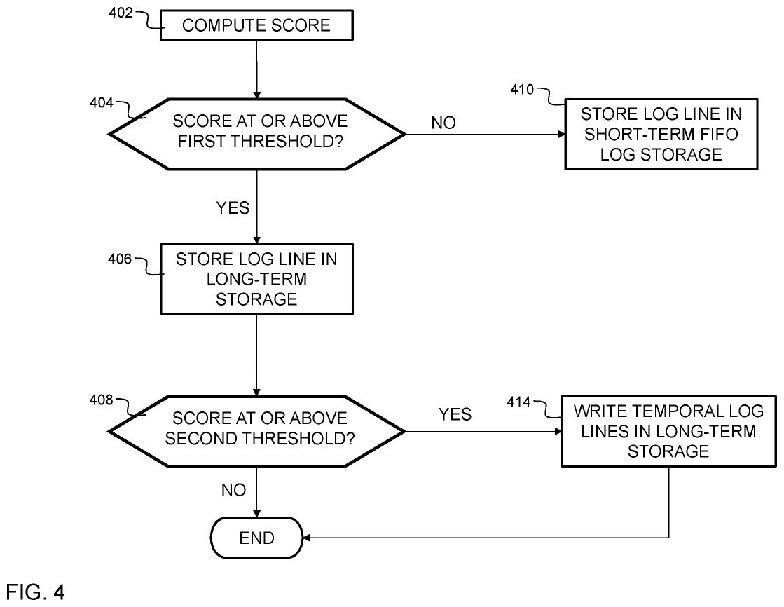

FIG. 4 is a flowchart 400 indicating process steps for additional embodiments of the present invention. At block 402, a score is computed, similar to as described for block 308 in FIG. 3. At block 404, a check is made to determine if the score is at or above a first threshold. In one or more embodiments, the score is normalized to have a value ranging from 0 (completely unimportant) to 100 (extremely important). Other embodiments can have different minimum and/or maximum limits. In some embodiments, the first threshold has a value in the range from 30 to 35. Other values are possible for the first threshold in some embodiments. If, at block 404, the score of a log line is not at or above the first threshold, then the log line is stored in the short-term FIFO log storage as indicated in block 410. Thus, embodiments can include, in response to the score being below a first predetermined threshold, storing the log line in a short-term FIFO storage. If, at block 404, the score of a log line is at or above the first threshold, then the log line is stored in the long-term storage as indicated in block 406. Thus, embodiments can include, in response to the score being at or above the first predetermined threshold and below a second predetermined threshold, storing the log line in a long-term storage. In embodiments, the second threshold is greater than the first threshold. In one or more embodiments, if, at block 404, the score is at or above the first threshold, the system enters a triggered state, enabling saving of X subsequent log lines to long-term storage at block 406, regardless of the importance of the subsequent log lines. As an example, if the value of X is 20, then the 20 lines following a log line deemed to be important, based on its score, are also written to the long-term storage. This can serve to provide additional context when reviewing logs. A higher value of X provides more history, but also can increase storage costs. Thus, in embodiments, the value of X may be a user-configurable option, allowing a user to fine-tune the system as he/she deems appropriate.

At block 408, a check is made to determine if the score is at or above a second threshold. In some embodiments, the second threshold has a value in the range from 70 to 75. Other values are possible for the second threshold in some embodiments. If, at block 408, the score of a log line is not at or above the first threshold, then the process ends. If, at block 408, the score of a log line is at or above the second threshold, then the short-term FIFO log storage is cleared at block 412, and the temporal log lines corresponding to the log line stored in the long-term storage at block 406 are written to the long-term storage at block 414. Thus, embodiments can include, in response to the score being at or above the first predetermined threshold and at or above the second predetermined threshold: storing the log line in a long-term storage; storing a first plurality of log lines that temporally precede the log line that was stored in the long-term storage, in the long-term storage; and storing a second plurality of log lines that temporally follow the log line that was stored in the long-term storage, in the long-term storage.

In some embodiments, in addition to, or instead of, storing temporal log lines in the short-term FIFO log storage, the temporal log lines may be stored in the long-term storage. Thus, embodiments can provide multiple levels of importance for log lines. Embodiments can include three levels of importance. As an example, if at block 404, the score is not at or above a first threshold, then the log line can be considered as not important. Similarly, if at block 404, the score is at or above a first threshold, but not at or above the second threshold at 408, then the log line can be considered as somewhat important. Similarly, if at block 408, the score is at or above the second threshold then the log line can be considered as very important. The storage strategy for a log line can be based on the importance. Embodiments can have more importance levels than three by utilizing additional thresholds.

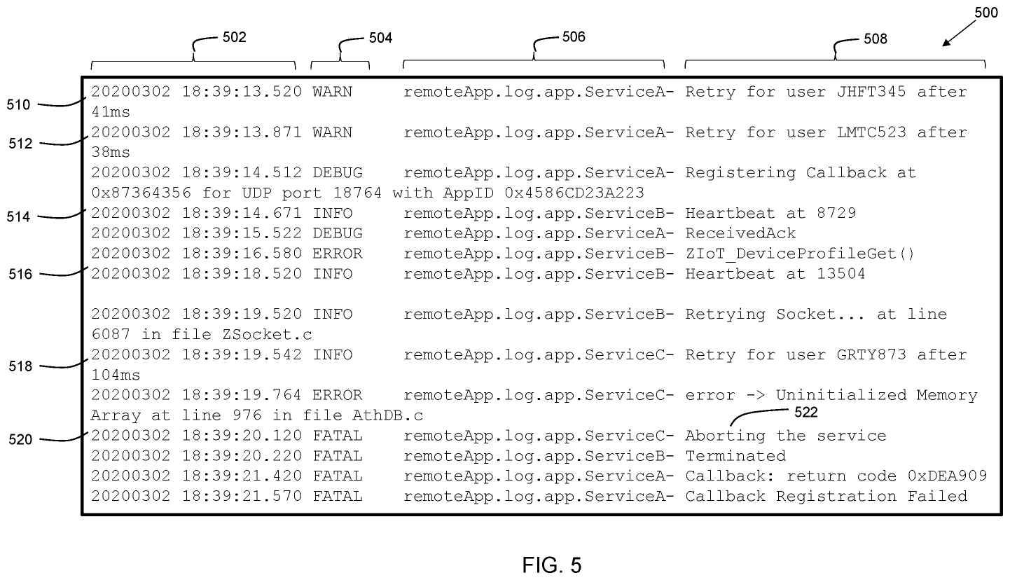

FIG. 5 shows an example of a log file 500 containing multiple log lines. Column 502 is a timestamp. For example, in line 510, the timestamp is “20200302 18:38:13.520” which indicates a date of Mar. 2, 2020, at a time of 18:38:13.520. In some embodiments, the time may be represented in UTC time. In other embodiments, the time may be represented in a local time zone. Column 504 represents a logging level. For example, in line 510, the logging level is WARN. In embodiments, there are multiple possible logging levels. Typically, the logging levels may reflect different levels of severity/importance of a particular log statement (line). In some embodiments, a log level of FATAL is used to output severe errors that cause premature termination of a software application. A log level of ERROR is used for output of runtime errors or unexpected conditions. A log level of WARN is used for warnings. The warnings can include programming errors such as incorrect use of API functions, and/or other runtime situations that are undesirable. A log level of INFO is used for informational events that are typically expected as part of normal software operation. A log level of DEBUG can include detailed information about system operation. A log level of TRACE can include the most detailed information. This information can be verbose and include hex dumps of data packets and other message details. These logging levels may be implemented by a logging library that is included in the software application, such as log 4j, log 4c, or other suitable logging library or utility.

The order of the logging levels, going from most severe to least severe may be arranged as FATAL, ERROR, WARN, INFO, DEBUG, and TRACE. During normal operation of deployed software, a logging level may be set at an intermediate logging level such as WARN. When the logging level is set to WARN, any logging statements of level WARN or above are output to consoles and/or logs. In this example, logging statements of level WARN, ERROR, and FATAL, are output, while logging statements of level INFO, DEBUG, and TRACE, are suppressed. In some embodiments, the logging level can be set to an intermediate level such as INFO, and unimportant log lines are identified and stored in the short-term FIFO log storage, while important lines are stored in the long-term storage.

Column 506 represents a component name. The component name can be a program, a module, a library, or some other executable entity. Referring to line 510, the component name is indicated as “remoteApp.log.app.ServiceA.” The component name may include an application name, and one or more subsystem names concatenated and separated by a period or other punctuation mark. In this example, the portion “remoteApp” may refer to a name of an overall software application and/or service. The subsequent sections “log” and “app” may refer to additional subcomponents of execution. The final portion, “ServiceA” may refer to a functional software component interacting with other software components.

Column 508 represents a logging statement. The logging statement represents information output by the component indicated at 506. Referring to line 510, the logging statement is “Retry for user JHFT345 after 41 ms.” Note that for display purposes, some lines may wrap to continue below the start of the line. For the purposes of this disclosure, each logging line starts with a timestamp. Thus, in the example, line 512 is the next logging line after 510. Referring to line 512, the logging statement is “Retry for user LMTC523 after 38 ms.” Disclosed embodiments can identify that line 510 and 512 are similar, except for the token following the word ‘user’ and the token following the word ‘after.’ Thus, in embodiments, a log template can be automatically created by the DCLSS 202 in the form of “Retry for user % s after % s.” This template also matches the log statement at log 518, which is “Retry for user GRTY873 after 104 ms.” While the log lines at 510, 512, and 518 do not match exactly, since they are the same statement but with different parameter data (e.g., users and number of milliseconds), they are treated as instances of the same log line for the purposes of novelty and throughput rate. Using the timestamps in column 502, an average throughput rate of number of occurrences per minute can be computed and recorded in the DCLSS 202. If the throughput rate increases or decreases significantly, it can be reflected in the score, thereby adjusting the storage location for the log line. In general, a retry may be considered as an indication of poor performance, and thus, an increase in throughput rate of such log lines is indicative of a problem, and can therefore result in an increase score to enable proper logging of the log lines. Embodiments can include determining a throughput rate for the log line; and wherein computing the score is further based on the throughput rate. In embodiments, computing the score comprises computing a higher score as a function of the throughput rate.

Referring to lines 514 and 516, they indicate log lines having a log template of “Heartbeat at % d” where “% d” represents an integer, such as 8729 in line 514, or 13504 in line 516. In this situation, a heartbeat log line may indicate that a process is running properly. If the process stalls, or terminates unexpectedly, the throughput of the log line decreases. In this situation, a decrease in throughput rate indicates a potential problem. Hence, in embodiments, computing the score comprises computing a higher score as an inverse function of the throughput rate.

Line 520 indicates a line that includes ‘Aborting the service’ which contains a keyword ‘Aborting’ as indicated at 522. In embodiments, a user may provide keywords as part of a configuration process. Embodiments can include obtaining at least one keyword; and wherein computing the score is further based on a rate of occurrence of the at least one keyword in the obtained log data. In embodiments, a word stemming process is used on the log lines. Stemming is the process of reducing a word to its stem that affixes to suffixes and prefixes or to the roots of words known as “lemmas.” As an example, the token ‘Aborting’ at 522 can be reduced to the lemma of ‘Abort’ and compared with predetermined keywords. If a lemma matches a predetermined keyword, then it increases the score, as previously described utilizing term KW (rt). In this way, users can customize the behavior of disclosed embodiments based on their knowledge of the types of log lines encountered in their systems.

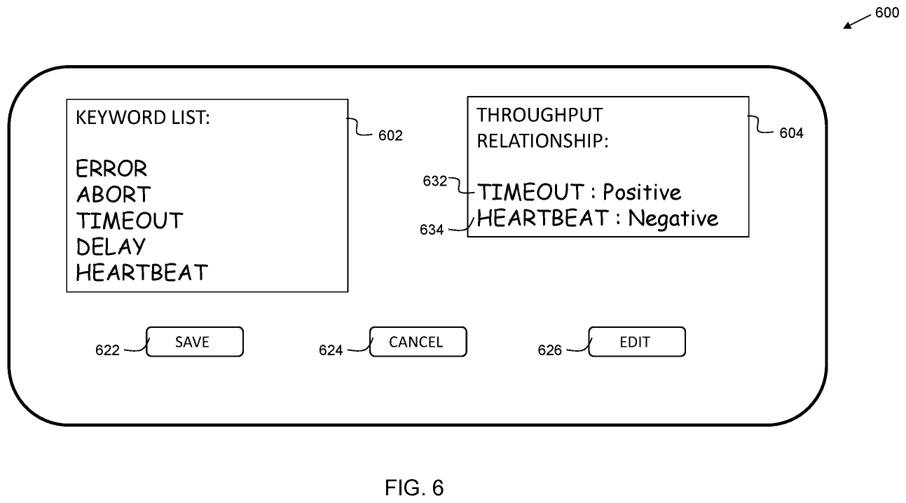

FIG. 6 is an exemplary user interface 600 in accordance with embodiments of the present invention. User interface 600 shows an example of a user-defined keyword list at field 602. The keyword list includes words such as ‘error,’ ‘abort,’ ‘timeout,’ ‘delay,’ and ‘heartbeat.’ If any of these keywords are found in a log template, it causes the score to increase, based on the formulas previously described utilizing term KW (rt). User interface 600 shows an example of a throughput relationship list at field 604. A user can configure how a change in throughput for a given keyword affects the score for a log line. At 632, the field contains the word ‘TIMEOUT’ with the modifier of ‘Positive’ which causes the DCLSS 202 to increase the score based on an increase in throughput of the token ‘TIMEOUT’ occurring in log data. At 634, the field contains the word ‘HEARTBEAT with the modifier of ‘Negative which causes the DCLSS 202 to increase the score based on a decrease in throughput of the token ‘HEARTBEAT occurring in log data. The user interface 600 includes a save button 622. Invoking the save button 622 causes the DCLSS 202 to save the keyword list in storage 244 of the DCLSS 202, and/or save it in another suitable location. The user interface 600 includes a cancel button 624. Invoking the cancel button 624 causes the DCLSS 202 to discard any changes made by a user since the last time data was saved. The user interface 600 includes an edit button 626. Invoking the edit button 626 causes the DCLSS 202 to enable a user to edit data in the keyword list field 602 and/or throughput relationship field 604. In embodiments, user interface 600 may be rendered on a client device such as 216 of FIG. 2. The user interface 600 may be rendered via an HTML page, Java, and/or other suitable user interface techniques.

As can now be appreciated, disclosed embodiments provide techniques to store only the important log records, such as those that are meaningful for troubleshooting a customer error for example, or log lines that are meaningful for building alerts for an Operations team. Disclosed embodiments automatically assess the importance of log lines by scoring them based on multiple criteria, such as novelty, throughput, parameter count, and/or user-specified keywords. Long-term storage is used for important log lines, while a lower-cost storage is used for log lines deemed to be unimportant based on the scoring. Embodiments can include multiple levels of importance. In embodiments multiple thresholds can be established, and based on the score of a given log line, as compared with the thresholds, a different action can be taken for storing the log line. In some embodiments, there are three levels of importance, such as ‘not important,’ ‘somewhat important,’ and ‘very important.’ A log line deemed to be not important is stored in a short-term FIFO buffer. It remains there for a period of time, until it is eventually overwritten. A log line deemed to be somewhat important is stored in long-term storage. A log line deemed to be very important can be stored in the long-term storage, along with storing log lines that are temporal to that log line in the short-term FIFO storage and/or long-term storage. In embodiments, the short-term FIFO storage may be a locally hosted storage, a local NAS (network-attached storage), or other storage that has little or no storage costs associated with it. The long-term storage can have a higher cost than the short-term FIFO storage, but provides the benefits of long-term storage such as increased accessibility, increased storage time, and/or increased data integrity. Thus, disclosed embodiments automatically prioritize important log lines for saving in more expensive, long-term storage, while diverting less important log lines to lower-cost, shorter-term storage, enabling the cost benefits of locally stored log files with the accessibility and redundancy benefits of long-term storage, thereby improving the technical field of computer device and software operations.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for log processing, comprising:
obtaining log data;
creating a log template based on the obtained log data;
identifying a parameter count in the log template;
computing a score for a log line within the log data that measures an estimated importance of the log line, wherein the score is a function of the parameter count; and
storing the log line to a storage location based on the score, wherein a different log line within the log data is stored to a different storage location based on a computed score associated with the different log line.

2. The method of claim 1, further comprising:
determining a novelty factor for the log line; and
wherein computing the score is further based on the novelty factor.

3. The method of claim 1, further comprising:
determining a throughput rate for the log line; and
wherein computing the score is further based on the throughput rate.

4. The method of claim 3, wherein a higher score is computed as a function of the throughput rate.

5. The method of claim 3, wherein a higher score is computed as an inverse function of the throughput rate.

6. The method of claim 1, further comprising:
obtaining at least one keyword; and
wherein computing the score is further based on a number of occurrences of the at least one keyword in the obtained log data.

7. The method of claim 1, further comprising:
in response to the score being below a first predetermined threshold, storing the log line in a short-term FIFO storage.

8. The method of claim 7, further comprising:
in response to the score being at or above the first predetermined threshold and below a second predetermined threshold, storing the log line in a long-term storage.

9. The method of claim 8, further comprising:
in response to the score being at or above the first predetermined threshold and at or above the second predetermined threshold:
storing the log line in a long-term storage;
storing a first plurality of log lines that temporally precede the log line that was stored in the long-term storage, in the long-term storage; and
storing a second plurality of log lines that temporally follow the log line that was stored in the long-term storage, in the long-term storage.

10. The method of claim 1, further comprising:
determining a novelty factor for the log line;
determining a throughput rate for the log line;
wherein computing the score is further based on the novelty factor and the throughput rate;
wherein in response to the score being below a first predetermined threshold, the log line is stored in a short-term FIFO storage;
wherein in response to the score being at or above the first predetermined threshold and below a second predetermined threshold, the log line is stored in a long-term storage; and
wherein in response to the score being at or above the first predetermined threshold and at or above the second predetermined threshold the method includes:
clearing the short-term FIFO storage;
storing the log line in a long-term storage;
storing a first plurality of log lines that temporally precede the log line that was stored in the long-term storage, in the short-term FIFO storage; and
storing a second plurality of log lines that temporally follow the log line that was stored in the long-term storage, in the short-term FIFO storage.

11. An electronic computation device comprising:
a processor;
a memory coupled to the processor, the memory containing instructions, that when executed by the processor, cause the electronic computation device to:
obtain log data;
create a log template based on the obtained log data;
identify a parameter count in the log template;
compute a score for a log line within the log data that measures an estimated importance of the log line, wherein the score is a function of the parameter count; and
store the log line to a storage location, wherein the storage location is based on the score, wherein a different log line within the log data is stored to a different storage location based on a computed score associated with the different log line.

12. The electronic computation device of claim 11, wherein the memory further comprises instructions, that when executed by the processor, cause the electronic computation device to:
determine a novelty factor for the log line; and
compute the score based on the novelty factor.

13. The electronic computation device of claim 11, wherein the memory further comprises instructions, that when executed by the processor, cause the electronic computation device to:
determine a throughput rate for the log line; and
compute the score based on the throughput rate.

14. The electronic computation device of claim 11, wherein the memory further comprises instructions, that when executed by the processor, cause the electronic computation device to:
obtain at least one keyword; and
compute the score based on a number of occurrences of the at least one keyword in the obtained log data.

15. The electronic computation device of claim 11, wherein the memory further comprises instructions, that when executed by the processor, cause the electronic computation device to:
in response to the score being below a first predetermined threshold, store the log line in a short-term FIFO storage.

16. The electronic computation device of claim 15, wherein the memory further comprises instructions, that when executed by the processor, cause the electronic computation device to:
in response to the score being at or above the first predetermined threshold and below a second predetermined threshold, store the log line in a long-term storage.

17. The electronic computation device of claim 16, wherein the memory further comprises instructions, that when executed by the processor, cause the electronic computation device to:
in response to the score being at or above the first predetermined threshold and at or above the second predetermined threshold:
store the log line in a long-term storage;
store a first plurality of log lines that temporally precede the log line that was stored in the long-term storage, in the long-term storage; and
store a second plurality of log lines that temporally follow the log line that was stored in the long-term storage, in the long-term storage.

18. A computer program product for an electronic computation device comprising a computer readable storage medium having program instructions embodied therewith, the program instructions executable by a processor to cause the electronic computation device to:
obtain log data;
create a log template based on the obtained log data;
identify a parameter count in the log template;
compute a score for a log line within the log data that measures an estimated importance of the log line, wherein the score is a function of the parameter count; and
store the log line to a storage location, wherein the storage location is based on the score, wherein a different log line within the log data is stored to a different storage location based on a computed score associated with the different log line.

19. The computer program product of claim 18, wherein the computer readable storage medium further comprises program instructions, that when executed by the processor, cause the electronic computation device to:
determine a novelty factor for the log line; and
compute the score based on the novelty factor.

20. The computer program product of claim 18, wherein the computer readable storage medium further comprises program instructions, that when executed by the processor, cause the electronic computation device to:
determine a throughput rate for the log line; and
compute the score based on the throughput rate.
